(19) United States
(12) Patent Application Publication
(10) Pub. No.: US 2010/0289959 A1
(43) Pub. Date: Nov. 18, 2010

(54) METHOD OF GENERATING A VIDEO SUMMARY

(75) Inventors: Pedro Fonseca, Eindhoven (NL); Mauro Barbieri, Eindhoven (NL); Enno Lars Ehlers, Hamburg (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 12/742,965

(22) PCT Filed: Nov. 14, 2008
(86) PCT No.: PCT/IB2008/054773

§ 371 Date: May 14, 2010

(30) Foreign Application Priority Data
Nov. 22, 2007 (EP) 07121307.8

(51) Int. Cl. H04N 5/445

(52) U.S. Cl. 348/564; 348/E05.099

(57) ABSTRACT

A method of generating a video summary of a content signal including at least a video sequence (18) includes classifying segments of the video sequence (18) into one of at least a first and a second class based on an analysis of properties of respective parts of the content signal and at least a first set of criteria for identifying segments (19-21) of the first class. A sequence (37) of images is formed by concatenating sub-sequences (38-40) of images, each sub-sequence (38-40) based at least partly on a respective segment (19-21) of the first class, such that in at least one of the sub-sequences (38-40) of images, moving images based on the respective segment (19-21) of the first class are displayed in a window of a first type. A representation of a segment (25-27) of the second class is caused to be displayed with at least some images of the sequence (37) of images in a window (41,42) of a different type.

### FIELD OF THE INVENTION

The invention relates to a method of generating a video summary of a content signal including at least a video sequence.

The invention also relates to a system for generating a video summary of a content signal including at least a video sequence.

The invention also relates to a signal encoding a video summary of a content signal including at least a video sequence. The invention also relates to a computer programme.

### BACKGROUND OF THE INVENTION

WO 03/060914 discloses a system and method for summarising a compressed video using temporal patterns of motion activity extracted in the compressed domain. The temporal patterns are correlated with temporal location of audio features, specifically peaks in the audio volume. By using very simple rules, a summary is generated by discarding uninteresting parts of the video and identifying interesting events.

A problem of the known method is that the summary can only be made smaller by making criteria for selecting the interesting events stricter, at a consequential loss of quality of the summary.

### SUMMARY OF THE INVENTION

It is an object of the invention to provide a method, system, signal and computer programme of the types mentioned in the opening paragraphs for providing relatively compact summaries perceived as being of relatively high quality in terms of their information content.

This object is achieved by the method according to the invention, which includes:

classifying segments of the video sequence into one of at least a first and a second class based on an analysis of properties of respective parts of the content signal and at least a first set of criteria for identifying segments of the first class, and

forming a sequence of images by concatenating sub-sequences of images, each sub-sequence based at least partly on a respective segment of the first class, such that

in at least one of the sub-sequences of images, moving images based on the respective segment of the first class are displayed in a window of a first type, and

which method further includes causing a representation of a segment of the second class to be displayed with at least some images of the sequence of images in a window of a different type.

The difference in type can involve any one of a different geometrical display format, different target display device or different screen location, for example.

By classifying segments of the video sequence into one of at least a first and a second class based on an analysis of properties of respective parts of the content signal and at least a first set of criteria for identifying segments of the first class, highlights in the video sequence are detected. An appropriate choice of first set of criteria ensures that these can correspond to the most informative segments, as opposed to the most representative, or dominant, segments. For example, an appropriate choice of criteria based on values of a classifier for segments of the first type would ensure that segments of a sports match in which points are scored (the highlights) are selected, as opposed to segments representing the playing field (the dominant parts). By concatenating sub-sequences of images, each sub-sequence based at least partly on a respective segment of the first class, it is ensured that the length of the sequence of images is determined by the highlights, making the summarising sequence relatively compact. By providing for classification of remaining segments of the input video sequence into at least the second class and by displaying with at least some of the sequence of images a representation of a segment of the second class, the sequence of images summarising the video sequence is made more informative. Because the moving images based on the respective segment of the first class are displayed in a window of a first type and representations of segments of the second class are in a window of a different type, the sequence of images summarising the content signal is compact and of relatively high quality. A viewer can distinguish between highlights and other types of elements of the summary.

In an embodiment, the representation of a segment of the second class is included in at least some of the sequence of images, such that the window of the first type is visually dominant over the window of the different type.

Thus, the relatively compact summary can be shown on one screen, and is relatively informative. In particular, more than just highlights can be shown, but it is clear which are the highlights and which representation is that of segments of secondary importance in the video sequence that has been summarised. Moreover, because the segments of the first class determine the length of the summary through the sub-sequence, the dominant part of the sequence of images is continuous, whereas the window of the different type need not be.

In an embodiment, a representation of a segment of the second class located between two segments of the first class is caused to be displayed with at least some of a sub-sequence of images based on the one of the two segments of the first class following the segment of the second class.

Thus, the video summary is established according to a rule aimed at maintaining a temporal order in the summary corresponding to the temporal order in the video sequence that has been summarised. An effect is to avoid confusing summaries that develop into two separate summaries displayed in parallel. The video summary is also more informative, since the segment of the second class located between two segments of the first class is most likely to relate to one of those two segments of the first class (i.e. to show a reaction or an event leading up to the event in the preceding or following segment of the first class), than to any other.

In an embodiment, the window of the different type is overlaid on a part of the window of the first type.

Thus, the window of the first type can be made relatively large, and the sub-sequences of images based at least partly on the segments of the first class can have a relatively high resolution. The extra information provided in the window of the second type does not come at a substantial cost to the information corresponding to the segments of the first class, provided the window of the different type is overlaid at an appropriate position.

In an embodiment, the segments of the second class are identified based on an analysis of respective parts of the content signal and at least a second set of criteria for identifying segments of the second class.

An effect is that the segments of the second class can be selected on the basis of different properties than those used to select segments of the first class. In particular, the segments of the second class need not be formed by all remaining parts of the video sequence that are not segments of the first class, for example. It will be apparent that the analysis on the basis of which the segments of the second class are identified, and which is used in conjunction with the second set of criteria, need not be the same type of analysis as that used to identify segments of the first class, although it could be.

In a variant, a segment of the second class is identified within a section separating two segments of the first class based at least partly on at least one of a location and contents of at least one of the two segments.

Thus, the method is capable of detecting segments of the second class that show reactions or antecedent events to at least one of the nearest segments of the first class (generally the highlights of the video sequence being summarised).

In an embodiment, the representation of the segment of the second class includes a sequence of images based on the segment of the second class.

An effect is to increase the amount of information relating to secondary parts of the video sequence to be summarised that is displayed.

A variant includes adjusting a length of the sequence of images based on the segment of the second class to be shorter or equal in length to a length of a sub-sequence of images based on a respective segment of the first class with which the sequence of images based on the segment of the second class is caused to be displayed. An effect is to allow the segments of the first class to determine the length of the video summary, and to add information whilst maintaining temporal order.

According to another aspect, the system for generating a video summary of a content signal including at least a video sequence according to the invention includes:

an input for receiving the content signal;

a signal processing system for classifying segments of the video sequence into

one of at least a first and a second class based on an analysis of properties of respective parts of the content signal and at least a first set of criteria for identifying segments of the first class, and for

forming a sequence of images by concatenating sub-sequences of images, each sub-sequence based at least partly on a respective segment of the first class, such that

in at least one of the sub-sequences of images, moving images based on the respective segment of the first class are displayed in a window of a first type,

wherein the system is arranged to cause a representation of a segment of the second class to be displayed with at least some images of the sequence of images in a window of a different type.

In an embodiment, the system is configured to execute a method according to the invention.

According to another aspect, the signal encoding a video summary of a content signal including at least a video sequence according to the invention encodes a concatenation of sub-sequences of images, each sub-sequence based at least partly on a respective segment of the video sequence of a first of at least a first and a second class, the segments of the first class being identifiable through use of an analysis of properties of respective parts of the content signal and a first set of criteria for identifying segments of the first class, and

moving images based on a segment of the first class being displayed in the respective sub-sequence in a window of a first type,

wherein the signal includes data for synchronous display of a representation of a segment of the second class in a window of a different type simultaneously with at least some of the concatenation of sub-sequences of images.

The signal is a relatively compact—in terms of its length—and informative video summary of the content signal.

In an embodiment, the signal is obtainable by executing a method according to the invention.

According to another aspect of the invention, there is provided a computer programme including a set of instructions capable, when incorporated in a machine-readable medium, of causing a system having information processing capabilities to perform a method according to the invention.

### BRIEF DESCRIPTION OF THE DRAWINGS

The invention will be explained in further detail with reference to the accompanying drawings, in which:

FIG. 1 illustrates a system for generating and displaying a video summary;

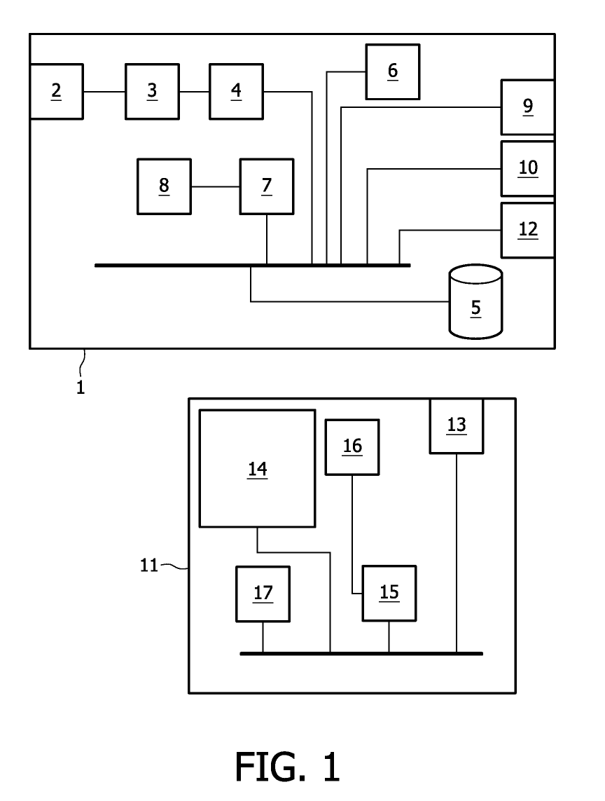

FIG. 2 is a schematic diagram of a video sequence to be summarised;

FIG. 3 is a flow chart of a method of generating the summary; and

FIG. 4 is a schematic diagram of a sequence of images comprised in a video summary.

### DETAILED DESCRIPTION

An integrated receiver decoder (IRD) 1 includes a network interface 2, demodulator 3 and decoder 4 for receiving digital television broadcasts, video-on-demand services and the like. The network interface 2 may be to a digital, satellite, terrestrial or IP-based broadcast or narrowcast network. The output of the decoder comprises one or more programme streams comprising (compressed) digital audiovisual signals, for example in MPEG-2 or H.264 or a similar format. Signals corresponding to a programme, or event, can be stored on a mass storage device 5 e.g. a hard disk, optical disk or solid state memory device.

The audiovisual data stored on the mass storage device 5 can be accessed by a user for playback on a television system (not shown). To this end, the IRD 1 is provided with a user interface 6, e.g. a remote control and graphical menu displayed on a screen of the television system. The IRD 1 is controlled by a central processing unit (CPU) 7 executing computer programme code using main memory 8. For playback and display of menus, the IRD 1 is further provided with a video coder 9 and audio output stage 10 for generating video and audio signals appropriate to the television system. A graphics module (not shown) in the CPU 7 generates the graphical components of the Graphical User Interface (GUI) provided by the IRD 1 and television system.

The IRD 1 interfaces with a portable media player 11 by means of a local network interface 12 of the IRD 1 and a local network interface 13 of the portable media player 11. This allows the streaming or otherwise downloading of video summaries generated by the IRD 1 to the portable media player 11.

The portable media player 11 includes a display device 14, e.g. a Liquid Crystal Display (LCD) device. It further includes a processor 15 and main memory 16, as well as a mass storage device 17, e.g. a hard disk unit or solid state memory device.

The IRD 1 is arranged to generate video summaries of programmes received through its network interface 2 and stored on the mass storage device 5. The video summaries can be downloaded to the portable media player 11 to allow a mobile user to catch up with the essence of a sporting event. They can also be used to facilitate browsing in a GUI provided by means of the IRD 1 and a television set.

The technique used to generate these summaries is explained using the example of sports broadcasts, e.g. of individual sports contests, but is applicable to a wide range of contents, e.g. movies, episodes of detective series, etc. Generally, any type of content comprising plots in arcs with an initial situation, a rising action leading to a climax and a subsequent resolution can be conveniently summarised in this way.

The purpose of summarisation is to present the essential information about a specific audiovisual content while leaving out information that is less important or less meaningful to the viewer in any way. When summarising sports, relevant information typically consists of a collection of the most important highlights in that sporting event (goals and missed opportunities in football matches, set points or match points in tennis, etc.). User studies have shown that, in an automatically generated sport summary, viewers would like to see not only the most important highlights, but also additional aspects of the event, such as, for example, the reaction of the players to a goal in a football match, crowd reaction, etc.

The IRD 1 provides enhanced summaries by presenting information in different ways according to its value in the summary. Less relevant parts that took place previously are displayed simultaneously with the currently showing essential part. This allows the video summaries to be compact yet highly informative.

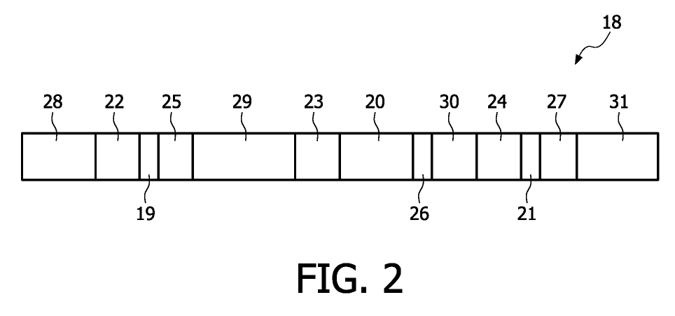

Referring to FIG. 2, a programme signal includes an audio component and a video component comprising a video sequence 18. The video sequence 18 includes first, second and third highlight segments 19-21. It also includes first, second and third lead-up segments 22-24 and first, second and third response segments 25-27, as well as sections 28-31 corresponding to other content.

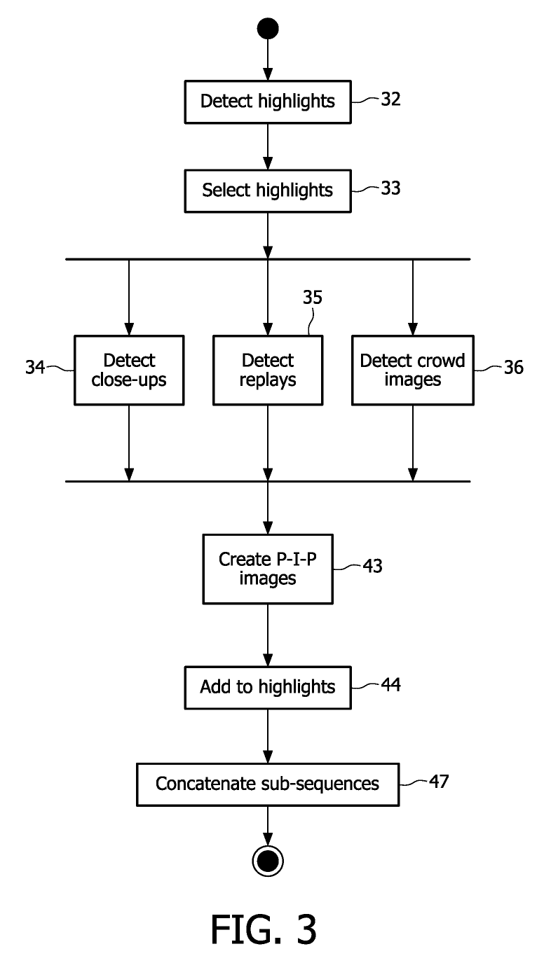

Referring to FIG. 3, a video summary is generated by detecting (step 32) the highlight segments 19-21 based an analysis of properties of those segments and at least a first heuristic for identifying the highlight segments. By heuristic is meant a particular technique for solving a problem, in this case identifying segments of a sequence of images corresponding to a highlight in a sporting event. It comprises the methods of analysis and the criteria used to determine whether a given segment is considered to represent a highlight. A first set of one or more criteria is used to identify highlights, whereas a second set of one or more criteria is met by other classes of segments. In the context of sporting events, suitable techniques for identifying segments that can be classified as highlights are described in Ekin, A.M. et al., “Automatic soccer video analysis and summarization”, IEEE Trans. Image Processing, June 2003; in Cabasson, R. and Divakaran, A., “Automatic extraction of soccer video highlights using a combination of motion and audio features”, Symp. Electronic Imaging: Science and Technology: Storage and Retrieval for Media Databases, January 2002, 5021, pp. 272-276; and in Nepal, S. et al., “Automatic detection of goal segments in basketball videos”, Proc. ACM Multimedia, 2001, pp. 261-269.

In a next step 33, which is optional, the classification is refined by selecting only certain ones of the segments identified in the preceding step 32. This step 33 can include ranking the segments found in the preceding step 32, and selecting only the ones ranked highest, e.g. a pre-determined number of segments, or a number of segments with a total length equal to or lower than a certain maximum length. It is noted that this ranking is carried out on only certain segments of the video sequence 18, namely those determined using a set of criteria applicable to highlights. It is thus a ranking of a set of segments constituting less than a complete partitioning of the video sequence 18.

Further steps 34-36, allow segments of a second class to be detected, e.g. the response segments 25-27. The reaction to a highlight typically includes replay of the highlight from multiple angles, often in slow-motion; a reaction of the players, often in close-up shots; and a reaction of the crowd.

The steps 34-36 are carried out on the basis of parts of the video sequence 18 separating two highlight segments 19-21 and based at least partly on at least one of location and contents of at least one of the two highlight segments 19-21, generally the first occurring one of the two highlight segments 19-21. The location is used, for example, where a response segment 25-27 is sought for each highlight segment 19-21. The contents are used in particular in a step 35 in which replays are looked for. In any case, segments are classified as response segments 25-27 using a different heuristic from the one used to classify segments as highlight segments 19-21. In this, the method differs from methods that aim to provide comprehensive summaries of a video sequence 18 by ranking segments representing a complete partitioning of the video sequence 18 into segments according to how representative the segments are of the contents of the entire video sequence 18.

A step 34 of detecting close-ups can make use of depth information. A suitable method is described in WO 2007/036823.

The step 35 of detecting replays can be implemented using any one of a number of known methods for detecting replay segments. Examples are described in Kobla, V. et al., “Identification of sports videos using replay, text, and camera motion features”, Proc. SPIE Conference on Storage and Retrieval for Media Database, 3972, January 2000, pp. 332-343; Wungt, L. et al., “Generic slow-motion replay detection in sports video”, 2004 International Conference on Image Processing (ICIP), pp. 1585-1588; and Tong, X., “Replay Detection in Broadcasting Sports Video”, Proc. 3^{rd} Intl. Conf on Image and Graphics (ICIG '04).

A step 36 of detecting crowd images can be implemented using, for example, a method described in Sadlier, D. and O′Connor, N., “Event detection based on generic characteristics of field-sports”, IEEE Intl. Conf on Multimedia & Expo (ICME), 5, 2005, pp. 5-17.

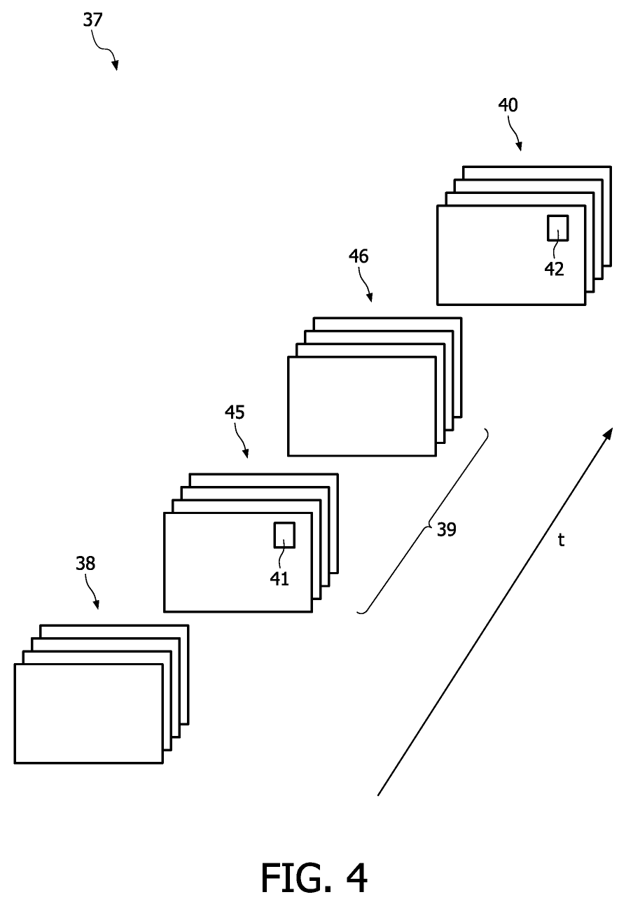

Referring to FIGS. 3 and 4 in combination, a sequence 37 of images forming the video summary is shown. It comprises first, second and third sub-sequences 38-40 based on the respective first, second and third highlight segments 19-21. The sub-sequences 38-40 are based on the highlight segments 19-21 in the sense that the images comprised therein correspond in contents, but may be temporally or spatially sub-sampled versions of the original images in the segments 19-21. The images in the sub-sequences 38-40 are encoded such as to occupy all of a first window of display on a screen of e.g. the display device 14 or a television set connected to the IRD 1. Generally, the first window will correspond in size and shape to the screen format so as to fill generally the entire screen, when displayed. It is observed that the sub-sequences 38-40 represent moving images, as opposed to single thumbnail images.

Images to fill on-screen windows 41,42 of a smaller format are created (step 43) on the basis of the response segments 25-27. These images are overlaid (step 44) on a part of the window containing the representation of a highlight segment 19-21 in Picture-In-Picture fashion. Thus, the moving images based on the highlight segments 19-21 are visually dominant over the representation of a response segment 25-27 added to it.

In one embodiment, the representations of the response segments 25-27 are single static images, e.g. thumbnails. In this embodiment, they may, for example, correspond to a key frame of the response segment 25-27 concerned. In another embodiment, the representations of the response segments 25-27 comprise sequences of moving images based on the response segments 25-27. In an embodiment, they are sub-sampled or truncated versions, adapted to be shorter or equal in length to a length of a sub-sequence 38-40 to which they are added. As a consequence, there is only at most one representation of a response segment 25-27 added to each sub-sequence 38-40.

To enhance the information content of the summary sequence 37, the temporal order of the original video sequence 18 is maintained to a certain extent. In particular, the representation of each response segment 25-27 located between two successive highlight segments 19-21 is caused to be displayed with at least some of only the sub-sequence 38-40 of images based on the one of the two highlight segments 19-21 following the response segment 25-27 concerned. Thus, in the example illustrated by FIGS. 2 and 4, a representation of the first response segment 25 is included in a window 41 in a first group 45 of images within the second sub-sequence 39 of images, which is based on the second highlight segment 20. The window 41 is not present in a second group of images within the second sub-sequence 39. A representation of the second response segment 26 is shown in a window 42 overlaid on the third sub-sequence 40 of images, which third sub-sequence 40 is based on the third highlight segment 21. The sub-sequences 38-40 with the overlaid windows 41,42 are concatenated in a final step 47 to generate an output video signal. Thus, the less relevant information of a previous highlight is displayed as a picture-in-picture simultaneously with relevant information of a current highlight, when the video summary sequence 37 is displayed.

It is observed that the representations of the response segments 25-27 are displayed on a different screen from the representations of the highlight segments 19-21 in another embodiment. For example, the sub-sequences of images based on the highlight segments 19-21 can be displayed on the screen of a television set connected to the IRD 1, whilst the representations of the response segments 25-27 are simultaneously displayed on the screen of the display device 14 at appropriate times.

It is further observed that several representations of response segments 25-27 may be overlaid on at least some of the sub-sequences 38-40 of images simultaneously. For example, there might be one window for representations of segments detected in the step 34 of detecting close-ups, another window for representations of segments detected in the step 35 of detecting replays and a further window for representations of segments detected in the step 36 of detecting crowd images.

In another embodiment, the windows 41,42 change position in dependence on the contents of the images on which they are overlaid, so as not to obscure relevant information.

In yet another embodiment, representations of the segments 22-24 are also included in the images forming the sub-sequences 38-40 or displayed in the windows 41,42 overlaid on these.

In any case, a compact and relatively informative sequence 37 summarising the video sequence 18 is obtained, suitable for quick browsing or mobile viewing on a device with limited resources.

It should be noted that the embodiments described above illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

For example, one or more of the steps 32-36 of detecting highlight segments 19-21 and response segments 25-27 can additionally or alternatively be based on an analysis of characteristics of an audio track synchronised with the video sequence 18 to be summarised and comprised in the same content signal.

‘Computer programme’ is to be understood to mean any software product stored on a computer-readable medium, such as an optical disk, downloadable via a network, such as the Internet, or marketable in any other manner.

1. Method of generating a video summary of a content signal including at least a video sequence (18), including:
classifying segments of the video sequence (18) into one of at least a first and a second class based on an analysis of properties of respective parts of the content signal and at least a first set of criteria for identifying segments (19-21) of the first class, and
forming a sequence (37) of images by concatenating sub-sequences (38-40) of images, each sub-sequence (38-40) based at least partly on a respective segment (19-21) of the first class, such that
in at least one of the sub-sequences (38-40) of images, moving images based on the respective segment (19-21) of the first class are displayed in a window of a first type,
which method further includes causing a representation of a segment (25-27) of the second class to be displayed with at least some images of the sequence (37) of images in a window (41,42) of a different type.

2. Method according to claim 1, wherein the representation of a segment (25-27) of the second class is included in at least some of the sequence (37) of images, such that the window of the first type is visually dominant over the window (41,42) of the different type.

3. Method according to claim 1, wherein a representation of a segment (25-27) of the second class located between two segments (19-21) of the first class is caused to be displayed with at least some of a sub-sequence (38-40) of images based on the one of the two segments (19-21) of the first class following the segment (25-27) of the second class.

4. Method according to claims 2 and 3, wherein the window (41,42) of a different type is overlaid on a part of the window of the first type.

5. Method according to claim 1 wherein the segments (25-27) of the second class are identified based on an analysis of respective parts of the content signal and at least a second set of criteria for identifying segments (25-27) of the second class.

6. Method according to claim 5, wherein a segment (25-27) of the second class is identified within a section separating two segments (19-21) of the first class based at least partly on at least one of a location and contents of at least one of the two segments.

7. Method according to claim 1, wherein the representation of the segment (25-27) of the second class includes a sequence of images based on the segment (25-27) of the second class.

8. Method according to claim 7, including
adjusting a length of the sequence of images based on the segment (25-27) of the second class to be shorter or equal in length to a length of a sub-sequence (38-40) of images based on a respective segment (19-21) of the first class with which the sequence of images based on the segment (25-27) of the second class is caused to be displayed.

9. System for generating a video summary of a content signal including at least a video sequence (18), including:
an input for receiving the content signal;
a signal processing system for classifying segments of the video sequence (18) into one of at least a first and a second class based on an analysis of properties of respective parts of the content signal and at least a first set of criteria for identifying segments (19-21) of the first class, and for
forming a sequence (37) of images by concatenating sub-sequences (38-40) of images, each sub-sequence (38-40) based at least partly on a respective segment (19-21) of the first class, such that
in at least one of the sub-sequences of images, moving images based on the respective segment (19-21) of the first class are displayed in a window of a first type,
wherein the system is arranged to cause a representation of a segment (25-27) of the second class to be displayed with at least some images of the sequence (37) of images in a window (41,42) of a different type.

10. System according to claim 9, configured to execute a method according to claim 1.

11. Signal encoding a video summary of a content signal including at least a video sequence (18),
wherein the signal encodes a concatenation of sub-sequences (38-40) of images, each sub-sequence (38-40) based at least partly on a respective segment of the video sequence (18) of a first of at least a first and a second class, the segments (19-21) of the first class being identifiable through use of an analysis of properties of respective parts of the content signal and a first set of criteria for identifying segments (19-21) of the first class, and
moving images based on a segment (19-21) of the first class being displayed in the respective sub-sequence (38-40) in a window of a first type,
wherein the signal includes data for synchronous display of a representation of a segment (25-27) of the second class in a window (41,42) of a different type simultaneously with at least some of the concatenation of sub-sequences (38-40) of images.

12. Signal encoding a video summary of a content signal including at least a video sequence (18),
wherein the signal encodes a concatenation of sub-sequences (38-40) of images, each sub-sequence (38-40) based at least partly on a respective segment of the video sequence (18) of a first of at least a first and a second class, the segments (19-21) of the first class being identifiable through use of an analysis of properties of respective parts of the content signal and a first set of criteria for identifying segments (19-21) of the first class, and
moving images based on a segment (19-21) of the first class being displayed in the respective sub-sequence (38-40) in a window of a first type,
wherein the signal includes data for synchronous display of a representation of a segment (25-27) of the second class in a window (41,42) of a different type simultaneously with at least some of the concatenation of sub-sequences (38-40) of images, obtainable by executing a method according to claim 1.

13. Computer programme including a set of instructions capable, when incorporated in a machine-readable medium, of causing a system having information processing capabilities to perform a method according to claim 1.
